(19) United States
(12) Patent Application Publication
(10) Pub. No.: US 2010/0139434 A1
(43) Pub. Date: Jun. 10, 2010

(54) REAR WINDSHIELD WIPER HAVING AN ELECTRIC DRIVE ARRANGEMENT FOR MOTOR VEHICLES

(75) Inventors: Mario Huesges, Buehlertal (DE); Detlef Lauk, Renchen (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/305,240

(22) PCT Filed: Jul. 12, 2007
(86) PCT No.: PCT/EP2007/057146

§ 371 Date: Dec. 17, 2008

(30) Foreign Application Priority Data
Sep. 8, 2006 (DE) 10 2006 042 321.6

(51) Int. Cl. F16H 1/16; H02K 15/00

(52) U.S. Cl. 74/425; 29/596

(57) ABSTRACT

The invention relates to a rear windscreen wiper comprising an electric drive assembly, in particular for a motor vehicle. Said wiper comprises an armature shaft (10) and an armature core (15), the armature shaft (10) being mounted by means of at least one anti-friction bearing (11) and also comprises a screw (12) for driving a drive mechanism. The armature shaft (10) is produced from bar stock that has a nominal diameter (13), which remains uniform over the length of the armature shaft (10), of between 5 mm and 7 mm, preferably 5.5 mm and 6.5 mm. To produce a frictional fit between the screw (12) and/or the anti-friction bearing (11) and/or the armature core (15), the assembly has at least one tumble finished structure (14).

### BACKGROUND OF THE INVENTION

The present invention relates to a rear windshield wiper having an electric drive arrangement for motor vehicles. Windshield wiper motors of this type are known, for example, for driving front windshield wipers.

According to the disclosure in German laid-open patent application DE 100 34 410 A1, a method for manufacturing a shaft of a drive arrangement for the adjustment drive of a window pane for a motor vehicle is known from a related technical field. By means of the method, disclosed in said document, for manufacturing an armature shaft of an electromotive drive for an adjustment drive of a window pane, in which method a bearing surface for the purpose of guidance in a shaft bearing is integrally formed onto at least one location by means of expulsion of material, it is possible, independently of the manufacturing process of the worm, very easily to provide a bearing surface for supporting the armature shaft. The burnish-rolling of worms on driveshafts provides a cost-effective possibility for providing such a worm because the material of the worm is composed of the material of the armature shaft. In this context, due to the process, there is no need for a subsequent metal-cutting process and the burnish-rolling can be used for the final shaping of the worm.

In addition, the electromotive drive has an armature shaft which extends with a uniform diameter over the entire length. An armature assembly, whose worm is burnish-rolled, is attached to the armature shaft. The worm can also be pressed, as a hollow worm element, onto the load-bearing section of the armature shaft.

A genus-forming electric drive arrangement is known from patent DE 40 39 453 C2. The electric drive arrangement is provided for driving a windshield wiper system of a motor vehicle. The windshield wiper system has a motor housing with an end shield and an armature shaft which is rotatably mounted by means of a roller bearing which is held in the end shield and has an inner ring and an outer ring. The armature shaft is supported axially on the inner ring of the roller bearing on both sides by means of radially projecting shoulders and, in particular, by means of snap rings which are pressed into annular grooves in the armature shaft. The axial forces are produced as a result of the toothing engagement of the worm in the worm wheel for driving the transmission arrangement, with the result that the axial forces can be applied to the inner ring of the roller bearing by means of the snap rings and by means of the radially projecting shoulders. In addition, a spring element, which couples the armature shaft in the direction of rotation to the inner ring in a frictionally locking fashion is introduced between the inner ring and the shoulder of the armature shaft. Furthermore, between the worm and the region on which the roller bearing is pressed onto the armature shaft there is further contouring in the armature shaft which has to be formed by means of metal-cutting processing. The armature shaft is supported at its transmission-side shaft end in a sprung fashion axially on the transmission pot. A pre-mounted cartridge is provided to provide a bearing for the means for supporting the armature shaft in the interior of the transmission pot in the form of a sealed blind hole in the transmission pot. In this context, the armature shaft has, in the region of the bearing, a smaller diameter than in the receptacle region of the roller bearing or of the armature assembly. The armature assembly therefore comprises a large number of changes in diameter which have to be manufactured in a metal-cutting fashion by means of costly fabrication methods. In addition, the arrangement of the roller bearing requires annular grooves to receive snap rings which also have to be formed by metal-cutting processing.

The known embodiments of drive arrangements which are provided specifically for driving a rear windshield wiper of a motor vehicle are derived from the design of drive arrangements for driving front windshield wipers and likewise have armature shafts which have a very complex configuration. Said armature shafts are frequently formed with diameter steps in order, on the one hand, to provide flexural rigidity in the region of the bearing and of the armature assembly and, on the other hand, to implement small head circle diameters of the worms. These can either be burnish-rolled or embodied as hollow worm elements, with the hollow worm elements having in each case a comparatively small bore diameter, with the result that a shaft diameter of, for example, 8 mm in the region of the bearings and the armature assembly is not suitable for receiving the hollow worm elements. This makes it necessary to provide a plurality of diameter steps within an armature shaft, which requires complex metal-cutting processing.

In addition, according to the prior art grooves and steps are provided within the shaft in order to receive the axial forces which also require metal-cutting processing. Owing to the large forces which occur when driving a rear windshield wiper, such electric drive arrangements are usually over-dimensioned. Although it is known to reduce the size of such drive arrangements for the purpose of integration in the tailgate or in the rear region of the vehicle, such modifications frequently give rise to complex configurations of armature shafts for reasons of fabrication technology.

### SUMMARY OF THE INVENTION

The object of the present invention is therefore to provide an electric drive arrangement for driving a rear windshield wiper of a motor vehicle having an armature shaft which permits a simple structural configuration and which can be manufactured with a relatively small number of fabrication steps.

This object is achieved on the basis of an electric drive arrangement for driving a rear windshield wiper of a motor vehicle, the drive arrangement having an armature shaft and an armature assembly, wherein the armature shaft is mounted by means of at least one roller bearing and comprises a worm for driving a transmission arrangement, characterized in that the armature shaft is manufactured from a bar material which has a uniform nominal diameter between 5 mm and 7 mm, preferably 5.5 mm and 6.5 mm, over the length of the armature shaft, wherein the armature shaft has at least one burnish-rolled part for connecting the worm and/or the roller bearing and/or the armature assembly in a frictionally locking fashion.

The invention includes the technical teaching that the armature shaft is manufactured from a bar material which has a uniform nominal diameter between 5 mm and 7 mm, preferably between 5.5 mm and 6.5 mm over the length of the armature shaft, with the armature shaft having at least one burnish-rolled part for connecting the worm and/or the roller bearing and/or the armature assembly in a frictionally locking fashion.

The invention is based here on the idea that the armature shaft is firstly manufactured from a bar material. The bar material has, in this context, a uniform nominal diameter between 5 and 7 mm, with the result that the armature shaft is constant over its entire length extending through the drive arrangement. The nominal diameter describes here a diameter which is within the conventional tolerance range for the fabrication of commercially available bar material. A diameter of 6 mm is preferably provided, but said diameter may, within the sense of the scope of protection, also deviate by 0.5 mm or more in the downward or upward directions. The preferred diameter of 6 mm describes a conventional tolerance range with a customary tolerance width of the tolerance zone for tolerances as per DIN-ISO.

A significant advantage of the drive arrangement according to the invention is the simplification which is obtained in the method of manufacturing the armature shaft from a uniform bar material which is passage-ground. Bar materials which are passage-ground have uniform surface qualities which are sufficient for pressing on, for example, a roller bearing or, for example, an armature assembly. Such bar materials which are passage-ground comprise, as a tool, very large lengths, with the result that the bar material has to be cut to the necessary length to manufacture the armature shaft, in which case the surface is manufactured by means of a continuous method for grinding so as to pass through. The cutting to length comprises merely a process of cutting the bar material in the longitudinal direction of the armature shaft, in which case brief subsequent processing of the ends of the bar material may be necessary in order to form the armature shaft. Such materials are also available as heat-treated steel, with the result that regions with different degrees of hardness can also be achieved in the further course of fabrication of the armature shaft by means of a single total or local heat treatment process.

According to one advantageous embodiment of the present invention there is provision for the worm to be burnish-rolled onto the bar material which is passage-ground. Rolling worms onto shafts is a very cost-effective fabrication possibility. Two shaping tools which face one another are pressed here into the bar material or the armature shaft which is formed, as a result of which the material in the shaping method is processed by means of plastic changing in shape in such a way that the contour of the worm can be formed by the bar material itself.

A further embodiment provides for the worm to be embodied as a hollow worm element which is fitted onto the armature shaft, in which case the armature shaft is burnish-rolled in the region of the hollow worm element.

The hollow worm element preferably has a bore for receiving the passage-ground bar material. Apart from the burnish-rolling for receiving the hollow worm element, there is therefore no need for a further processing step for fabricating the bar material. Tolerance pairing can be provided only between the diameter of the bore of the hollow worm element and the diameter of the passage-ground bar material in order to press the hollow worm element advantageously onto the armature shaft and for this purpose produce a frictionally locking connection. It is not necessary here to change the armature shaft in diameter in the region of the receptacle of the hollow worm element. Conventional hollow worm elements have, in one exemplary embodiment, a worm foot diameter which can be used with a 6 mm bore for use in a drive arrangement for driving a rear windshield wiper of a motor vehicle.

According to a further exemplary embodiment, the armature shaft has a burnish-rolled part in at least one region which extends laterally with respect to the roller bearing. The nominal diameter of the passage-ground bar material and the bore diameter of the roller bearing can produce a tolerance pairing with the result that the roller bearing can be pressed onto the armature shaft. The form fit can be strengthened by previous burnish-rolling of the armature shaft at the region of contact with the roller bearing with the result that axial forces which are applied to the armature shaft via the worm can be received by means of the roller bearing, and the armature shaft is supported in the axial direction by means of the roller bearing. In addition, in order to assist the axial securement of the roller bearing on the armature shaft there is the possibility of performing burnish-rolling laterally, i.e. to the left and right of the roller bearing, as a result of which a shoulder is produced with a diameter which is slightly larger than the nominal diameter, with the result that the roller bearing is secured axially.

As an alternative to forming a shoulder, a structure which has elevations which likewise extend beyond the nominal diameter of 6 mm so that, as a result, it is possible to bring about positively locking axial securement of the roller bearing on the armature shaft can be rolled in by means of plastic shaping through the burnish-rolling of the surface of the armature shaft.

It is likewise possible to roughen the armature shaft, or slightly shape it plastically, in the region of the roller bearing before the fitting on of the roller bearing by means of burnish-rolling, in such a way that during the subsequent fitting on of the roller bearing said roller bearing presses on the armature shaft to a greater extent so that, as a result, increased security against axial sliding of the roller bearing on the armature shaft can be achieved.

According to a further exemplary embodiment of the present invention there is provision for an armature assembly to be pressed onto the armature shaft, in which case the section of the armature shaft which receives the armature assembly has at least partially a surface structure region which brings about increased friction between the armature shaft and the armature assembly. It is possible for the surface structure region to have been processed by burnish-rolling in this context.

The surface structure region can also be provided by means of knurling or some other plastic shaping of the surface in part of the armature shaft, in which case the armature assembly is subsequently fitted onto the armature shaft. It is to be noted here that the armature assembly can also be attached to the armature shaft without changing the surface in order to form a surface structure region by means of form fitting or a materially joined connection such as, for example, by means of an adhesive or the like.

The worm, the roller bearing and the armature packet are arranged at structurally minimum distances from one another on the armature shaft in order to minimize bending moments, with the result that the nominal diameter of 6 mm is sufficient for the flexural rigidity of the armature shaft. Possible changes in shape of the armature shaft as a result of burnish-rolling can be compensated by dressing the shaft, in which case the severity of the burnish-rolling can be kept small in such a way that distortion of the armature shaft does not become apparent.

According to a further exemplary embodiment of the invention, the armature shaft can be mounted at least one further bearing point in a sliding bearing which also has a nominal diameter of 6 mm. In this way, there can be a transition of the armature shaft from the receptacle areas of the worm, the roller bearing and of the armature assembly directly into a region of the sliding bearing without metal-cutting processing being necessary. It is to be noted here that the sliding bearing can be formed by the armature shaft itself. It is also possible for a sliding bearing inner ring to be pressed onto the shaft.

The present invention also comprises a method for manufacturing an electric drive arrangement for the drive of a rear windshield wiper of a motor vehicle having an armature shaft which is mounted in at least one roller bearing and also comprises a worm for driving a transmission arrangement, wherein the method comprises the steps that the armature shaft is manufactured by cutting into length a bar material which is passage-ground, the armature shaft is burnish-rolled at the locations provided for receiving the components, the worm is formed on and/or in the armature shaft, the roller bearing is pressed onto the armature shaft, and the armature assembly is fitted on. The attachment of the worm also comprises either rolling the worm onto the armature shaft or pressing a hollow worm element onto the armature shaft. In addition, after the roller bearing has been provided at least one region extending laterally with respect to the roller bearing the method comprises burnish-rolling in order to secure the roller bearing axially on the armature shaft.

Further measures which improve the invention are illustrated in more detail below with reference to the figure together with the description of a preferred exemplary embodiment of the invention.

### BRIEF DESCRIPTION OF THE DRAWINGS

In the drawings:

FIG. 1 is a schematic illustration of an armature shaft according to the present invention in which the worm is embodied as a hollow worm element;

FIG. 2 is a schematic illustration of the armature shaft according to the present invention in which the worm is manufactured by burnish-rolling, and

FIG. 3 shows an armature shaft according to the prior art.

### DETAILED DESCRIPTION

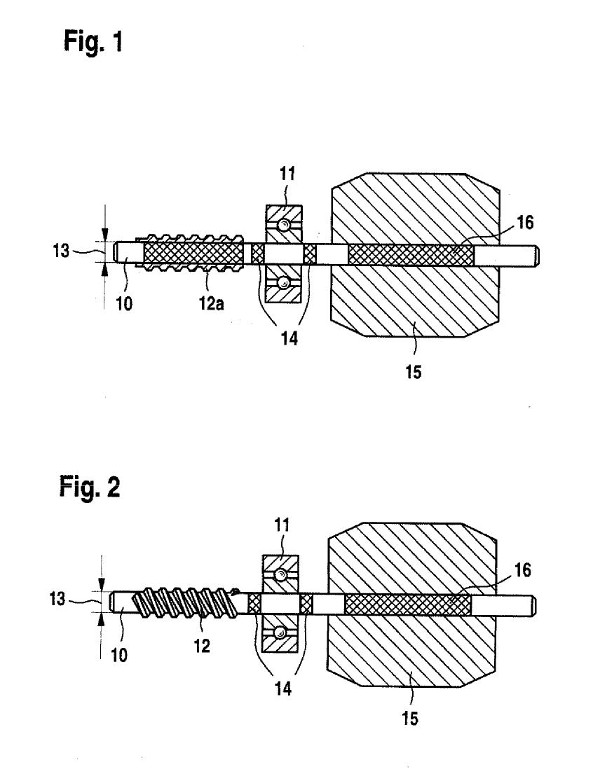

FIG. 1 is a schematic illustration of an armature shaft 10 which has an improved configuration according to the present invention. The armature shaft 10 is manufactured from a passage-ground bar material and has, in this exemplary embodiment, a constant nominal diameter 13 of approximately 6 mm over its entire length. The diameter of the armature shaft 10 can, however, also be selected from the range between 5 mm and 7 mm, preferably 5.5 mm and 6.5 mm, depending on the embodiment. The internal diameter of the worm 12, which is embodied as a hollow worm element 12, is also approximately 6 mm in this exemplary embodiment. The hollow worm element 12 is pressed onto the armature shaft 10, with the result that a frictionally locking connection is provided between the hollow worm element 12 and the armature shaft 10. In order to reinforce the press fit between the hollow worm element 12 and the armature shaft 10, the armature shaft 10 is burnish-rolled in the region of the hollow worm element 12.

A roller bearing 11 is fitted onto the armature shaft 10 and attached in an axially secured fashion to the armature shaft 10 by means of a form fit. As is also the case with the hollow worm element 12, the roller bearing 11 has a bore with a nominal diameter of 6 mm. In order to ensure security against axial displacement of the roller bearing 11 with respect to the armature shaft 10, the region of the armature shaft 10 which extends to the left and right of the roller bearing 11 is provided with a respective burnish-rolled part 14. The burnish-rolled part 14 brings about plastic deformation of the material of the armature shaft 10, which in this exemplary embodiment forms a shoulder against which the roller bearing 11 is supported. As a result, all the axial forces occurring within the armature shaft 10 can be absorbed by the roller bearing 11. The roller bearing 11 is embodied here in the manner of a ball bearing.

The burnish-rolling is carried out by means of a shaping tool which is pressed radially against the armature shaft 10 while said armature shaft 10 is made to rotate. The principle of burnish-rolling is based on plastic deformation of the surface of the bar material of the armature shaft 10, in which case either knurling with a peak-valley structure can be produced, or a lateral shoulder edge can be provided in the armature shaft 10 by means of a shaping tool.

A surface structure region 16 which serves to receive the armature assembly 16 in a frictionally locking fashion is also illustrated. The armature assembly 15 is pressed axially onto the armature shaft 10 and it is only illustrated schematically in this exemplary embodiment. It comprises a metallic armature with a winding and a collector which is fed and commutated electrically by means of carbon brushes.

FIG. 2 shows a schematic illustration of the armature shaft 10 according to FIG. 1 in which, however, the worm 12 is formed in the armature shaft 10 by means of burnish-rolling. The shaping tool for producing the worm 12 comprises a negative of the worm contour, with the result that the worm 12 is formed from the material of the armature shaft 10 itself. As is also illustrated in FIG. 1, the illustration of the armature shaft in FIG. 2 comprises an armature assembly 15 which is applied in a frictionally locking fashion to the armature shaft 10 by means of a surface structure region 16. In this exemplary embodiment the nominal diameter 13 is also 6 mm and it extends over the entire length of the armature shaft 10. The roller bearing 11 is secured axially on the armature shaft 10 by means of left-handed and right-handed burnish-rolled parts 14.

With regard to fabrication technology, the burnish-rolling of the worm 12 can take place first in order to compensate, inter alia, possible dimensional deviations within the shaping tolerance of the armature shaft 10. In addition, heat treatment of at least the burnish-rolled region of the worm 12 can be provided. Alternatively it is possible to produce the worm 12 by means of a cold extrusion method, which can also bring about corresponding material hardness values.

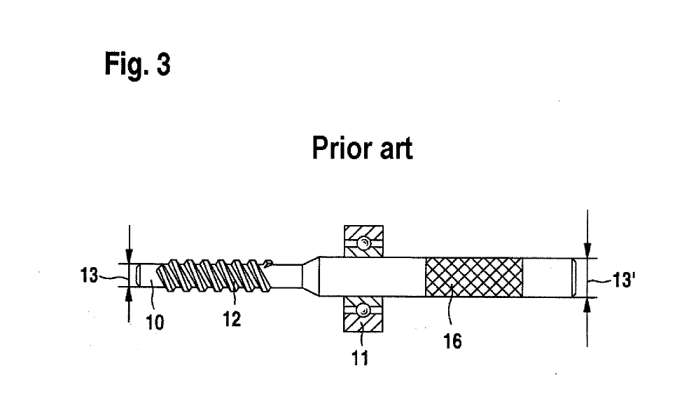

FIG. 3 shows an armature shaft 10 with a nominal diameter according to the prior art. A worm is attached to the armature shaft 10. The armature shaft 10 does not have a nominal diameter which extends over the entire length, as in the exemplary embodiments according to the invention, but rather a widened portion on a further nominal diameter 13′ which is larger in this case. A roller bearing 11a and a surface structure region 16a for receiving the armature assembly (not illustrated in more detail) is provided on the nominal diameter 13′. The manufacture of the armature shaft 10 requires a considerable expenditure on fabrication since different diameter regions have to be produced by means of a metal-cutting fabrication method.

The invention is not limited in its embodiment to the preferred exemplary embodiment specified above. Instead, it is conceivable to have a number of variants which make use of the illustrated solution even with embodiments which are of a fundamentally different nature.

1. A rear windshield wiper having an electric drive arrangement having an armature shaft (10) and an armature assembly (15), wherein the armature shaft (10) is mounted by means of at least one roller bearing (11) and comprises a worm (12) for driving a transmission arrangement, characterized in that the armature shaft (10) is manufactured from a bar material which has a uniform nominal diameter (13) between 5 mm and 7 mm over the length of the armature shaft (10), wherein the armature shaft (10) has at least one burnish-rolled part (14) for connecting the worm (12) and/or the roller bearing (11) and/or the armature assembly (15) in a frictionally locking fashion.

2. The rear windshield wiper having an electric drive arrangement as claimed in claim 1, characterized in that the armature shaft (10) is passage-ground.

3. The rear windshield wiper having an electric drive arrangement as claimed in claim 1, characterized in that the worm (12) is embodied in one piece with the armature shaft (10), in particular is burnish-rolled from the armature shaft (10).

4. The rear windshield wiper having an electric drive arrangement as claimed in claim 1, characterized in that the worm (12) is embodied as a hollow worm element (12a) which is attached to the armature shaft (10).

5. The rear windshield wiper having an electric drive arrangement as claimed in claim 4, characterized in that the hollow worm element (12a) has a bore for receiving the armature shaft (10) which is designed so as to be complementary to the nominal diameter (13).

6. The rear windshield wiper having an electric drive arrangement as claimed in claim 1, characterized in that the roller bearing (11) is arranged in the region of the burnish-rolled part of the armature shaft (10) in such a way that it is connected in an axially secured fashion to the armature shaft (10).

7. The rear windshield wiper having an electric drive arrangement as claimed in claim 1, characterized in that the armature shaft (10) has a burnish-rolled part (14) in at least one region which extends laterally with respect to the roller bearing (11).

8. The rear windshield wiper having an electric drive arrangement as claimed in claim 1, characterized in that the armature shaft (10) is mounted on at least one further bearing point by means of a sliding bearing which has a diameter which is complementary to the nominal diameter (13).

9. A method for manufacturing an electric drive arrangement for a rear windshield wiper of a motor vehicle, which comprises the following steps:
an armature shaft (10) is manufactured by cutting into length a bar material which is, in particular, passage-ground, with a nominal diameter which is essentially constant;
the armature shaft (10) is burnish-rolled at least in certain regions;
the worm (12) is formed on and/or in the armature shaft (10);
a roller bearing (11) is pressed onto the armature shaft (10); and
an armature assembly (15) is fitted on.

10. The method as claimed in claim 9, characterized in that the worm (12) is embodied in one piece with the armature shaft by virtue of the fact that it is introduced into the armature shaft (10) by means of burnish-rolling.

11. The method as claimed in claim 8, characterized in that, after the roller bearing (11) has been attached to at least one region which extends laterally with respect to the roller bearing (11), the armature shaft (10) is burnish-rolled.

12. The rear windshield wiper having an electric drive arrangement as claimed in claim 1, characterized in that the armature shaft (10) is manufactured from a bar material which has a uniform nominal diameter (13) between 5.5 mm and 6.5 mm.
